(19) United States
(12) Patent Application Publication
(10) Pub. No.: US 2023/0306149 A1
(43) Pub. Date: Sep. 28, 2023

(54) MANAGEMENT OF VIRTUAL REPRESENTATIONS IN A COMPUTING ENVIRONMENT USING UNIQUE IDENTIFIERS

(71) Applicant: Dell Products L.P., Round Rock, TX (US)

(72) Inventor: Madhukar Gaganam, Leander, TX (US)

(21) Appl. No.: 17/703,028

(22) Filed: Mar. 24, 2022

(51) Int. Cl. G06F 30/20

(52) U.S. Cl. CPC G06F 30/20; G06F 2111/02

(57) ABSTRACT

Techniques are disclosed for managing virtual representations (e.g., digital twins) in a computing environment. For example, a method comprises assigning identifiers to virtual representations of physical items within a computing environment. Each one of the virtual representations is assigned an identifier that is unique with respect to each other one of the virtual representations. The method then manages the virtual representations within the computing environment using the identifiers.

### FIELD

The field relates generally to computing environments, and more particularly to managing virtual representations (e.g., digital twins) in such computing environments.

### BACKGROUND

Techniques have been proposed to attempt to model and/or simulate infrastructure in a computing environment so as to more efficiently manage the infrastructure including attributes and operations associated with the infrastructure. One proposed way to model and/or simulate the infrastructure is through the creation of a digital twin architecture. A digital twin typically refers to a virtual representation or a virtual copy of a physical (e.g., actual or real) item such as, but not limited to, a system, a device, and/or processes associated therewith. By way of example, a digital twin can be used to analyze and understand performance of the physical item in order to achieve improved operations in the physical item, as well as in the computing environment in which the physical item is implemented. However, the management of digital twins in a computing environment can be a significant challenge.

### SUMMARY

Embodiments provide techniques for managing virtual representations in a computing environment.

For example, according to one illustrative embodiment, a method comprises assigning identifiers to virtual representations of physical items within a computing environment. Each one of the virtual representations is assigned an identifier that is unique with respect to each other one of the virtual representations. The method then manages the virtual representations within the computing environment using the identifiers.

Further illustrative embodiments are provided in the form of a non-transitory computer-readable storage medium having embodied therein executable program code that when executed by a processor causes the processor to perform the above steps. Additional illustrative embodiments comprise an apparatus with a processor and a memory configured to perform the above steps.

Advantageously, illustrative embodiments manage virtual representations (e.g., digital twins) in a computing environment (e.g., a distributed computing environment) using a unique identifier name space.

These and other features and advantages of embodiments described herein will become more apparent from the accompanying drawings and the following detailed description.

### BRIEF DESCRIPTION OF THE DRAWINGS

FIG. 1 illustrates a digital twin environment according to an illustrative embodiment.

FIG. 2 illustrates a distributed computing environment with multiple digital twins according to an illustrative embodiment.

FIG. 3 illustrates a digital twin management environment using unique identifiers according to an illustrative embodiment.

FIGS. 4A and 4B illustrate an exemplary unique identifier format for managing multiple digital twins according to an illustrative embodiment.

FIG. 5 illustrates a digital twin system architecture according to an illustrative embodiment.

FIG. 6 illustrates an architecture for a digital twin according to an illustrative embodiment.

FIG. 7 illustrates a methodology for digital twin management using unique identifiers according to an illustrative embodiment.

FIG. 8 illustrates a processing platform for an information processing system used to implement digital twin management functionality according to an illustrative embodiment.

### DETAILED DESCRIPTION

Illustrative embodiments will now be described herein in detail with reference to the accompanying drawings. Although the drawings and accompanying descriptions illustrate some embodiments, it is to be appreciated that alternative embodiments are not to be construed as limited by the embodiments illustrated herein. Furthermore, as used herein, the term “includes” and its variants are to be read as open-ended terms that mean “includes, but is not limited to.” The term “based on” is to be read as “based at least in part on.” The term “an embodiment” and “the embodiment” are to be read as “at least one example embodiment.” The terms “first,” “second,” and the like may refer to different or the same objects. Other definitions, either explicit or implicit, may be included below.

As mentioned, digital twins are virtual representations of physical items that are used to analyze and understand the physical item in order to achieve improved performance outcomes. For example, such a virtual representation can be embodied as one or more software programs that model, simulate, or otherwise represent attributes and operations of the physical item. Further, a digital twin may alternatively be illustratively referred to as a digital twin object or digital twin module, or simply as a digital object or digital module. A digital twin acts as a bridge between the physical and digital worlds and can be created by collecting real-time data about the physical item. The data is then used to create a digital duplicate of the physical item, allowing the physical item and/or the environment in which the physical item operates in real-time to be understood, analyzed, manipulated, and/or improved.

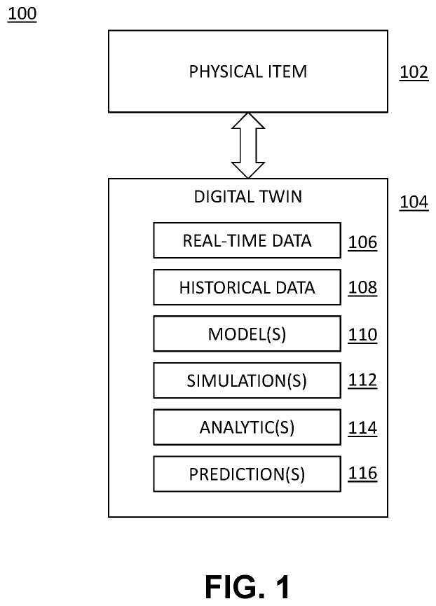

FIG. 1 illustrates a digital twin environment 100 according to an illustrative embodiment. As shown, by way of example only, a physical item 102 is operatively coupled to a digital twin 104. While a single instance of digital twin 104 is depicted, it is to be understood that physical item 102 may be virtually represented by more than one instance of digital twin 104 (e.g., same internal configurations) and/or by two or more different versions (e.g., different internal configurations) of digital twin 104. It is to be understood that the term physical item as illustratively used herein may include, but is not limited to, a hardware-based item, a software-based item, and a combination thereof. That is, for example, the digital twin may virtually represent a hardware component (e.g., a system, a device, etc.), a software component (e.g., program code executable on a hardware component that performs or causes performance of an operation, a process, etc.), and combinations thereof.

Digital twin 104 is configured as shown with components comprising real-time data 106, historical data 108, one or more models 110, one or more simulations 112, one or more analytics 114, and one or more predictions 116. In general, digital twin 104 obtains real-time data 106, as well as other data, from physical item 102. Based on the real-time data 106, previously obtained historical data 108, and/or other data, digital twin 104 functions as a digital duplicate of physical item 102 and executes all or a subset of the one or more models 110, the one or more simulations 112, the one or more analytics 114, and the one or more predictions 116 to analyze and understand the attributes (e.g., parameters, settings, etc.) and operations (e.g., computations, functions, etc.) of physical item 102. Based on at least a portion of the results from execution of the one or more models 110, the one or more simulations 112, the one or more analytics 114, and the one or more predictions 116, digital twin 104 can then be used to manipulate the attributes and operations of physical item 102 to optimize or otherwise improve the operations of physical item 102.

However, there are significant challenges that arise with existing approaches to managing such digital twins. For example, it is realized that technical problems exist in terms of managing the identities of each digital twin within a distributed computing environment.

Illustrative embodiments provide techniques for identifying multiple digital twins within a distributed computing environment using an identifier notation/format to create a unique identifier name space that enables improved management of the multiple digital twins within the distributed computing environment.

Before describing illustrative embodiments of the unique identifier name space, a non-limiting example of a distributed computing environment in which digital twins can be deployed will first be described. It is to be appreciated, however, that embodiments are not limited to any particular environment.

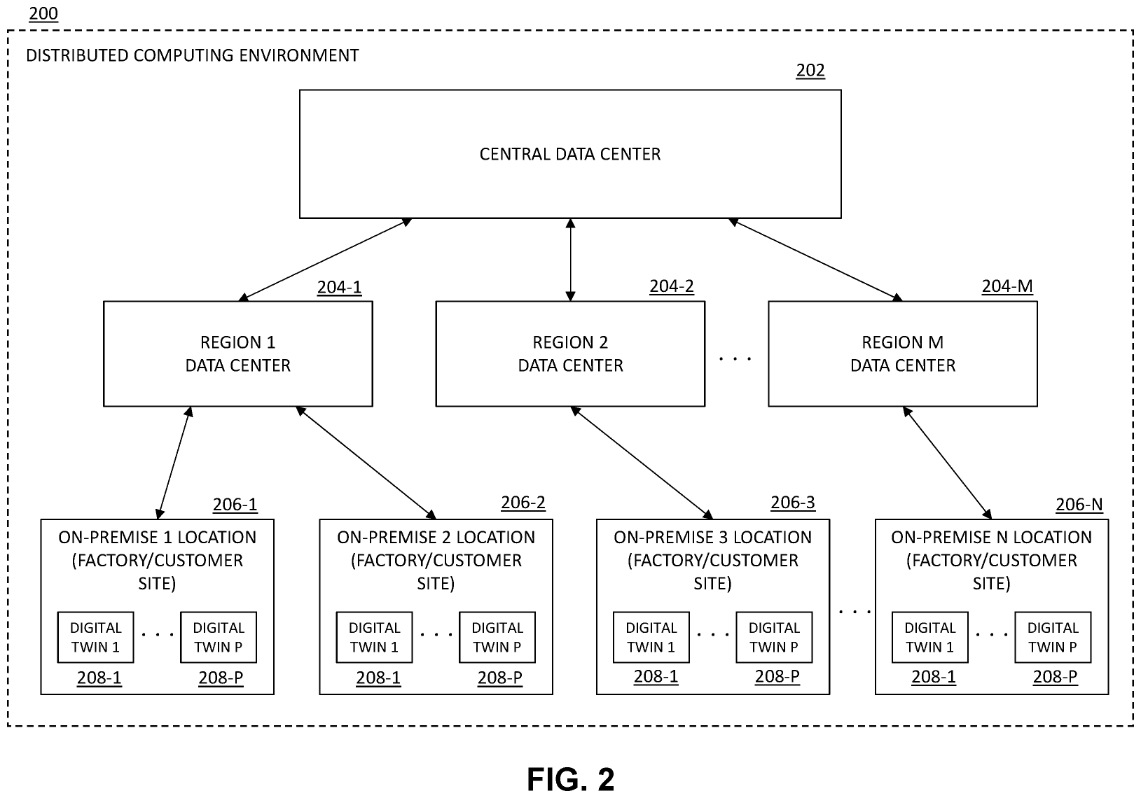

FIG. 2 illustrates a distributed computing environment 200 according to an illustrative embodiment. As used in this example, the term distributed refers to a computing environment wherein a plurality of digital twins respectively represents a plurality of units of equipment (i.e., physical systems/processes or other items) that may be remotely located at factories and/or customer sites in the computing environment. For example, digital twins located at factories can be used to model/simulate and manipulate equipment during a manufacturing process by a manufacturing entity (e.g., an original equipment manufacturer or OEM) for eventual deployment at a customer site. Then, after deployment, digital twins can be used to model/simulate and manipulate the equipment during real-time operations by the customer. Management of these digital twins at the remote factories/customer sites may need to be accomplished across a distributed computing environment comprising a central data center that communicates with one or more regional data centers that then communicate with the factories/customer sites. In some embodiments, such a distributed computing environment may include one or more cloud computing platforms (e.g., public, private, and/or hybrid) and one or more edge computing platforms, as well as other intermediate computing platforms and systems, as needed/desired.

Thus, as shown in FIG. 2, distributed computing environment 200 comprises a central data center 202 operatively coupled to a region 1 data center 204-1, a region 2 data center 204-2, . . . , and a region M data center 204-M (hereinafter referred to collectively as regional data centers 204 or individually as regional data center 204). Each regional data center 204 is operatively coupled to one or more factories/customer sites: region 1 data center 204-1 is operatively coupled to on-premise 1 location 206-1 and on-premise 2 location 206-2; region 2 data center 204-2 is operatively coupled to on-premise 3 location 206-3; and region M data center 204-M is operatively coupled to on-premise N location 206-N(hereinafter referred to collectively as on-premise locations 206 or individually as on-premise location 206). As further shown, each on-premise location 206 comprises a plurality of digital twins 208-1, . . 208-P (hereinafter referred to collectively as digital twins 208 or individually as digital twin 208). Recall that each digital twin 208 virtually represents a specific unit of equipment (i.e., physical system/process or other item) located at an on-premise location 206. By way of example only, one or more of digital twins 208 can be configured the same or similar to digital twin 104 as shown in FIG. 1.

It is to be appreciated that distributed computing environment 200 is only one example of a distributed computing environment in which digital twins 208, requiring management, may reside. Alternative distributed computing environments may have different configurations with larger or smaller numbers of data centers, on-premise locations, and/or other computing platforms. Also, although distributed computing environment 200 illustrates computing platforms and on-premise locations that are geographically distant, the term distributed is not necessarily limited to geographically distant configurations. That is, one or more on-premise locations 206 may be geographically collocated, and the same is feasible with respect to regional data centers 204 and/or central data center 202. Still further, embodiments are not limited to any specific number of digital twins 208 that can reside within distributed computing environment 200.

Given the explanation of illustrative distributed computing environment 200 with the plurality of digital twins 208 residing therein, digital twin management using unique identifiers according to an illustrative embodiment will now be explained.

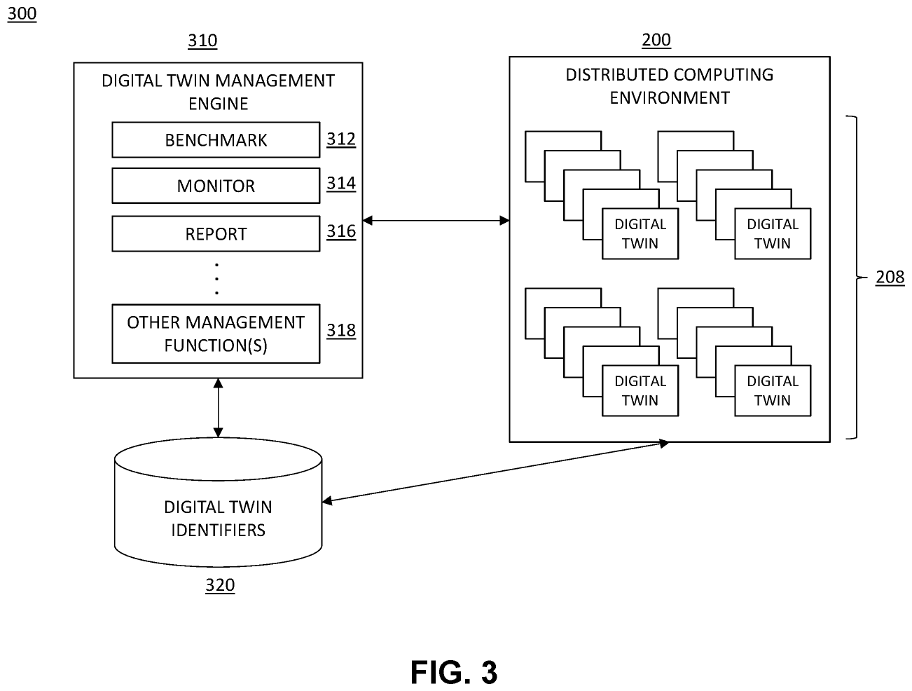

FIG. 3 illustrates digital twin management environment 300 using unique identifiers according to an illustrative embodiment. As shown, a digital twin management engine 310 is operatively coupled to distributed computing environment 200 comprising digital twins 208 (as shown in FIG. 2). Recall from FIG. 2 that digital twins 208 can be located at multiple on-premise locations 206. The number of on-premise locations 206 can be large and, thus, the number of digital twins 208 can be even larger (e.g., tens, hundreds, thousands, etc.). For digital twins 208 to be managed, they need to be accessed, e.g., read from and written to remotely across the various computing platforms and locations that comprise distributed computing environment 200, e.g., central data center 202, regional data centers 204, and on-premise locations 206. As such, it is realized herein that it is advantageous for each digital twin 208 to be uniquely identified within distributed computing environment 200.

Accordingly, illustrative embodiments provide an identifier notation to uniquely identify and address each digital twin 208 across distributed computing environment 200 to enable digital twin management engine 310 to access and thus manage each digital twin 208. Management of digital twins 208 is dependent on the wide variety of attributes and operations of the units of equipment that digital twins 208 virtually represent. By way of example only, as shown in FIG. 3, digital twin management engine 310 is configured to perform a benchmark function 312 (e.g., comparing performance metrics of the units of equipment which the digital twins virtually represent to one or more standards, goals, preferences, and/or requirements), a monitor function 314 (e.g., obtaining and tracking data from the digital twins and/or units of equipment, as well as receiving data from other systems and/or users), a report function 316 (e.g., sending data to the digital twins and/or units of equipment, as well as sending data to other systems and/or users), as well as one or more other management functions 318.

Thus, digital twin management engine 310 is configured to access each digital twin 208 via a unique identifier for each digital twin 208, which are assigned and maintained for look up in a digital twin identifier store 320 operatively coupled to digital twin management engine 310 and distributed computing environment 200.

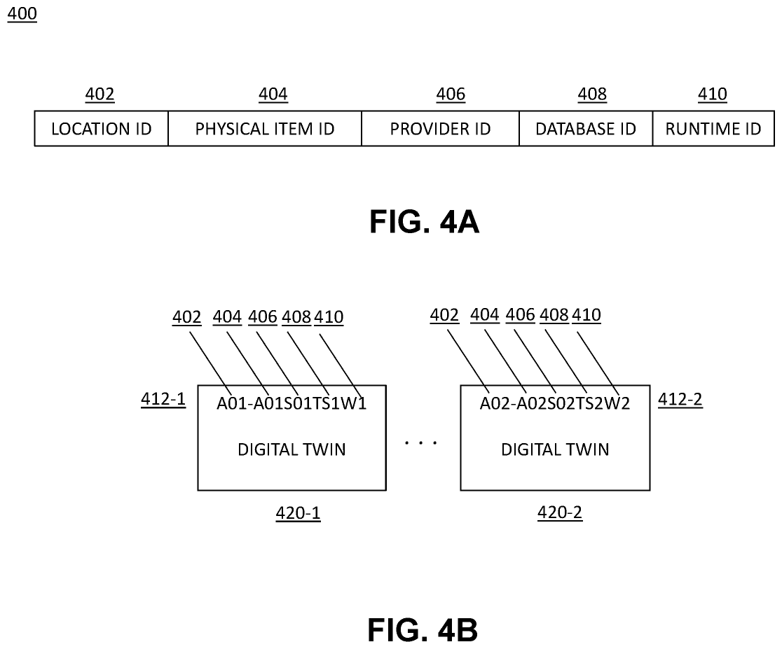

FIGS. 4A and 4B illustrate an exemplary unique identifier format (e.g., notation) for creating a name space for managing multiple digital twins according to an illustrative embodiment. It is to be appreciated that while the figures depict one or more illustrative embodiments of unique identifier formats for digital twins, alternative embodiments are contemplated with different unique identifier formats.

FIG. 4A shows a digital twin identifier format 400 which comprises a set of identifier (ID) fields that are settable during assignment to uniquely identify each digital twin 208 within distributed computing environment 200. As shown, the set of identifier fields comprises a location ID 402, a physical item ID 404, a provider ID 406, a database ID 408, and a runtime ID 410 for a given one of digital twins 208.

Location ID 402 is an identifier field that uniquely represents the location within distributed computing environment 200 at which the given digital twin 208 resides, e.g., one of on-premise locations (factory/customer site) 206. Note that digital twins 208 managed using unique identifiers may reside at locations other than on-premise locations 206 (e.g., central data center 202, regional data centers 204, and/or other locations). Note also that the physical item virtually represented by the digital twin may be co-located with the digital twin, or may reside at another location.

Physical item ID 404 is an identifier field that uniquely represents the type of physical item (e.g., system and/or process) that the given digital twin 208 virtually represents. By way of example only, the physical item that the given digital twin 208 represents can be an asset such as a robot, a computer numerical control (CNC) machine, manufacturing process equipment, etc.

Provider ID 406 is an identifier field that uniquely represents the provider (e.g., vendor, manufacturer, etc.) of the physical item (e.g., system and/or process) that the given digital twin 208 virtually represents. By way of example only, the provider of the physical item that the given digital twin 208 represents can be a company such as Allen Bradley, Siemens, ABB, Emerson, etc.

Database ID 408 is an identifier field that uniquely represents the type of data (database) that is processed by the given digital twin 208. For example, the given digital twin 208 may receive and process data from the physical system/process which it represents including data from a time series database, a relational database, a data lake etc.

Runtime ID 410 is an identifier field that uniquely represents the runtime environment (e.g., operating system, hypervisor, programming language, etc.) of the physical item (e.g., system and/or process) that the given digital twin 208 virtually represents. By way of example only, the runtime environment may comprise Java and operating systems such as Lynx, Windows, Ubuntu, Symbian, QNX, VRTX, or AWS, GCS, Azure, etc.

It is to be appreciated also that the order, definition and/or composition of the identifier fields 402, 404, 406, 408 and 410 can be different than that shown in FIG. 4A in alternative embodiments.

In some embodiments, each identifier field 402, 404, 406, 408 and 410 can have one or more place values that can be set to numbers, letter and/or other symbols. FIG. 4B illustrates examples of each identifier field 402, 404, 406, 408 and 410 in digital twin identifier format 400 for a digital twin 420-1 and a digital twin 420-2.

As shown, identifier 412-1 (A01-A01S01TS1W1) is uniquely assigned to and thus uniquely identifies digital twin 420-1 throughout distributed computing environment 200, while identifier 412-2 (A02-A02S02TS2W2) is uniquely assigned to and thus uniquely identifies digital twin 420-2 throughout distributed computing environment 200.

Identifier 412-1 is depicted as A01-A01S01TS1W1 wherein A01 in identifier field 402 is the on-premise location 206 at which digital twin 420-1 (and presumably, but not necessarily, the physical item that digital twin 420-1 virtually represents) resides, A01 in identifier field 404 is the type of physical item virtually represented by digital twin 420-1, S01 in identifier field 406 is the provider of the physical item, TS1 in identifier field 408 is the database type associated with the data leveraged by digital twin 420-1, and W1 in identifier field 410 is the runtime environment of the physical item, e.g., a given version of Windows. Now compare identifier 412-1 to identifier 412-2 which is depicted as A02-A02S02TS2W2. Note that each identifier field is incremented by one denoting that digital twin 420-2 virtually represents a different physical item provided by a different provider with a different database type and different runtime environment, and that is located at a different on-premise location 206, than digital twin 420-1.

Again, it is to be understood that the specific choice of alphanumeric values used in the identifier fields of identifiers 412-1 and 412-2 in FIG. 4B are examples and not intended to limit to the scope of other illustrative embodiments.

Accordingly, returning to FIG. 3, by illustrative embodiments assigning a unique identifier (e.g., as illustratively shown in FIGS. 4A and 4B) to each digital twin 208, digital twin management engine 310 is able to access each digital twin 208 within distributed computing environment 200 to perform one or more management functions (e.g., benchmark 312, monitor 314, report 316, other management functions 318). By way of example only, assume digital twin management engine 310 seeks to monitor all or a subset of digital twins 208 at both on-premise locations 206-1 and 206-2 that are associated with region 1 data center 204-1. Digital twin management engine 310 is configured to look up the unique identifier in digital twin identifiers store 320 to find the unique identifier for each specific digital twin 208 it seeks to monitor. A monitoring command (query) can be sent to each digital twin 208 using its unique identifier as an address to effectuate the monitoring function (e.g., instruct each digital twin 208 to perform some operation and/or transmit information back to digital twin management engine 310). It is further understood that each computing platform (e.g., central data center 202 and regional data centers 204) and on-premise location 206 in distributed computing environment 200 is configured to access digital twin identifiers store 320 or otherwise know the unique identifiers assigned to each digital twin 208 so as to enable them to address or otherwise recognize each digital twin 208.

Note that while digital twin management engine 310 is illustrated in FIG. 3 as a single standalone component, it is to be appreciated that portions of digital twin management engine 310 can alternatively be implemented in multiple components and/or in one or more of the computing platforms (e.g., central data center 202 and regional data centers 204) and on-premise locations 206 in distributed computing environment 200. Likewise, digital twin identifiers store 320 can alternatively be implemented within digital twin management engine 310 or implemented in multiple components and/or in one or more of the computing platforms (e.g., central data center 202 and regional data centers 204) and on-premise locations 206 in distributed computing environment 200.

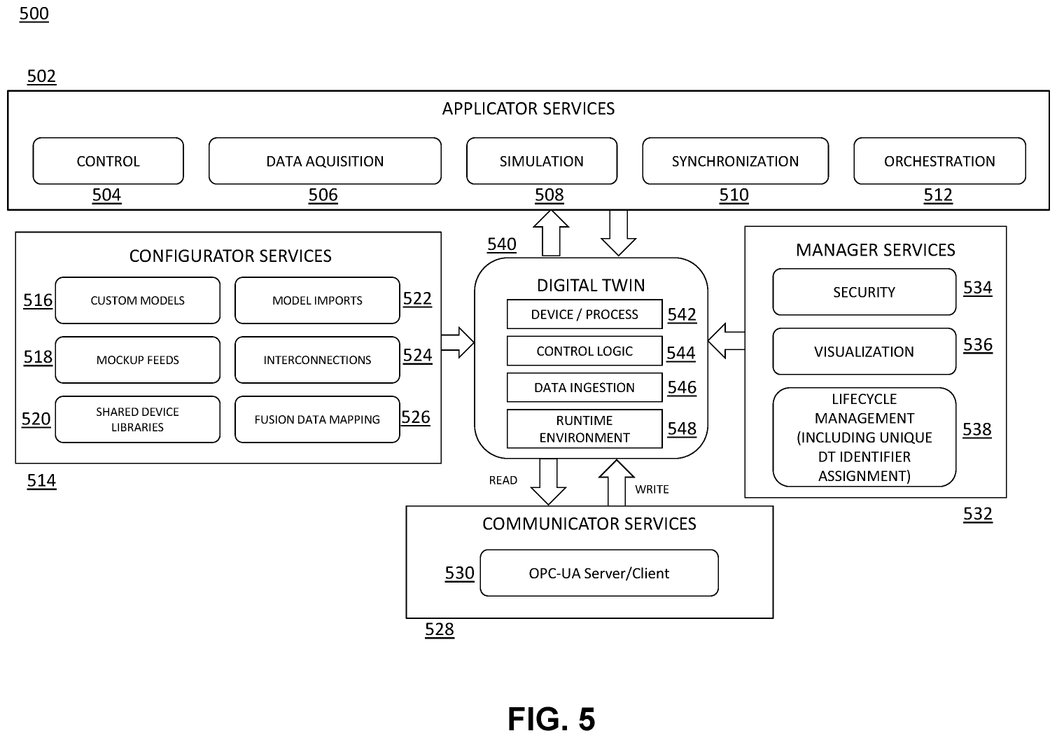

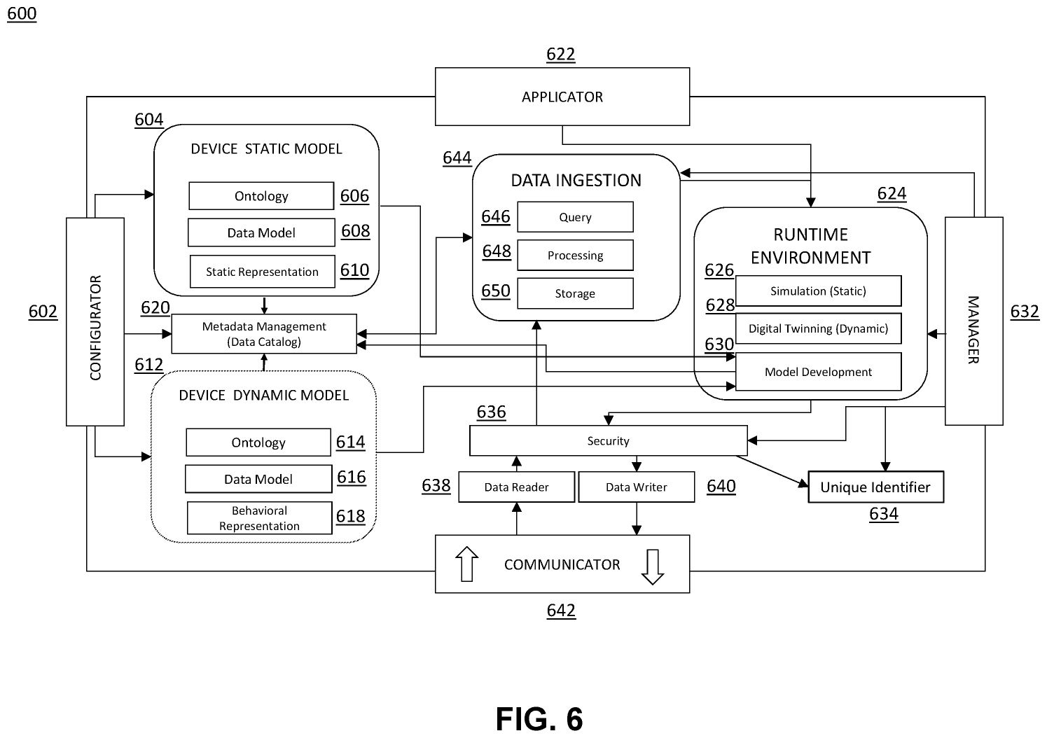

Turning now to FIGS. 5 and 6, architectures for implementing digital twins according to an illustrative embodiment are depicted. More particularly, FIG. 5 illustrates a digital twin system architecture 500 for generating and managing one or more digital twins, while FIG. 6 illustrates a digital twin architecture 600 generated by digital twin system architecture 500. Note that, in some embodiments, digital twin management engine 310 and digital twin identifiers store 320 can be implemented as digital twin system architecture 500, while one or more digital twins 208 can be generated and deployed as digital twin architecture 600.

As shown in FIG. 5, digital twin system architecture 500 comprises an applicator services module 502, itself comprising a control module 504, a data acquisition module 506, a simulation module 508, a synchronization module 510, and an orchestration module 512. In general, modules 504 through 512 of applicator services module 502 enable a digital twin architect to specify the functionalities of the digital twin that is being generated and deployed. For example, control module 504 is configured to provide management of the applicator services of applicator services module 502, whereas each of the other modules 506, 508, 510 and 512 are configured to respectively provide applicator services of data acquisition, simulation, synchronization, and orchestration during the course of generating and otherwise managing a digital twin.

Further, digital twin system architecture 500 comprises a configurator services module 514, itself comprising a custom models module 516, a mockup feeds module 518, a shared device libraries module 520, a model imports module 522, an interconnections module 524, and a fusion data mapping module 526. In general, modules 516 through 526 of configurator services module 514 enable a digital twin architect to specify what components are needed in the digital twin to provide the functionalities of the digital twin specified by applicator services module 502. For example, configurator services module 514 enables the architect to specify that the digital twin will have one or more custom models (e.g., customized models for the specific use case of the digital twin) via custom models module 516, and one or more imported models (e.g., standardized models for the specific use case of the digital twin) via model imports module 522. Also, configurator services module 514 enables specification, by the architect, of testing interconnections for the digital twin via mockup feeds module 518, as well as real-time interconnections between the digital twin and the physical item it simulates via interconnections module 524. Still further, device libraries, via shared device libraries module 520, can be loaded on, or otherwise accessible to, the digital twin. Fusion data mappings (e.g., mappings between data generated by the physical item and data generated by the digital twin) can also be specified and implemented in the digital twin via fusion data mapping module 526.

Still further, digital twin system architecture 500 comprises a communicator services module 528 itself comprising a data exchange module 530 (e.g., OPC-UA server/client) that, in general, enables communication and data exchange between digital twin system architecture 500 and the digital twin that is being created and deployed.

Digital twin system architecture 500 further comprises a manager services module 532 itself comprising a security module 534, a visualization module 536, and a lifecycle management module 538. In general, modules 534 through 538 of manager services module 532 enable a digital twin architect to specify security, visualization and lifecycle management functionalities to be applied to the digital twin being created and deployed. Security functionalities are use case specific, as are visualization (e.g., dashboard) functionalities. Further, lifecycle management module 538 is configured to, inter alia, assign a unique digital twin identifier (e.g., FIGS. 4A and 4B) to the digital twin.

Lastly, as shown in FIG. 5, a digital twin 540 is created and deployed by digital twin system architecture 500 for a given physical item (device/process) 542 with control logic 544, data ingestion functionality 546 and runtime environment support 548. The control, data ingestion and runtime functionalities are specific to the physical item that digital twin 540 is being generated to simulate. Further details of digital twin 540 are described below in the context of FIG. 6.

As shown in FIG. 6, digital twin architecture 600 comprises a configurator module 602 that is configured to interface with configurator services module 514 of digital twin system architecture 500. Digital twin architecture 600 further comprises a device static model 604 which, through configurator module 602, is configured with an ontology 606, a data model 608 and a static representation 610 suitable for the physical item being virtually represented by digital twin architecture 600. Further, digital twin architecture 600 comprises a device dynamic model 612 which, through configurator module 602, is configured with an ontology 614, a data model 616 and a behavioral representation 618 suitable for the physical item being virtually represented by digital twin architecture 600. Still further, a metadata management module 620 is operatively coupled to device static model 604 and device dynamic model 612, and is configured, through configurator module 602, with a data catalog suitable for the physical item being virtually represented by digital twin architecture 600.

Further shown in FIG. 6, digital twin architecture 600 comprises an applicator module 622 that is configured to interface with applicator services module 502 of digital twin system architecture 500. Digital twin architecture 600 further comprises a runtime environment 624 which, through applicator module 622, is configured with a static simulation module 626, a dynamic digital twinning module 628 and a model development module 630 suitable for the physical item being virtually represented by digital twin architecture 600.

Digital twin architecture 600 comprises a manager module 632 that is configured to interface with manager services module 532 of digital twin system architecture 500 to enable assignment of and/or other identifier management functions for a unique identifier 634. In one or more illustrative embodiments, unique identifier 634 is generated having digital twin identifier format 400 which comprises, as shown in FIG. 4A, a set of identifier (ID) fields that are settable during assignment to uniquely identify a digital twin (i.e., digital twin architecture 600) in a computing environment (e.g., distributed computing environment 200 of FIG. 2) within which it is deployed. Non-limiting examples of unique identifier 634 are identifier 412-1 or identifier 412-2 in FIG. 4B. Manager module 632 also enables management of security module 636 which securely controls communications for digital twin architecture 600. Note that communications with digital twin architecture 600 are effectuated via a data reader 638 and a data writer 640 which are operatively coupled to a communicator module 642. Communicator module 642 interfaces with communicator services module 528 of digital twin system architecture 500 during generation and real-time operational stages, as well as with the physical item being virtually represented by digital twin architecture 600.

Digital twin architecture 600 also comprises a data ingestion module 644 that is operatively coupled to metadata management module 620, runtime environment 624, manager module 632 and security module 636, and that is configured to provide a query module 646, a processing module 648, and a storage module 650 suitable for managing data and queries ingested in accordance with the physical item being virtually represented by digital twin architecture 600.

It is to be appreciated that embodiments of the unique digital twin identifier name space described herein are not necessarily limited to either digital twin system architecture 500 or digital twin architecture 600.

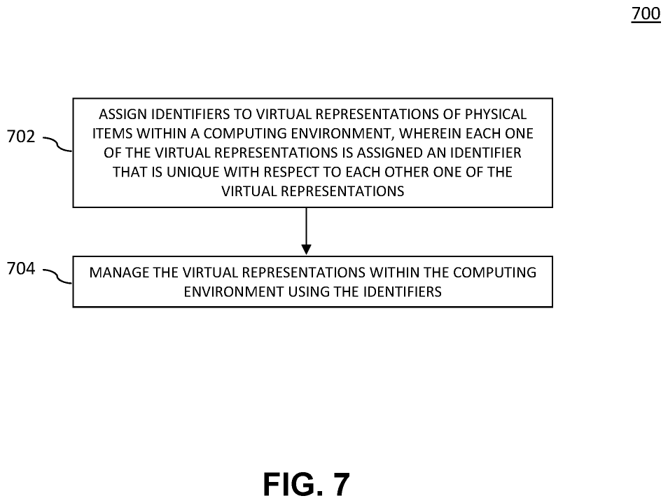

FIG. 7 illustrates a methodology 700 for digital twin management using unique identifiers according to an illustrative embodiment. As shown, step 702 assigns identifiers to virtual representations of physical items within a computing environment, wherein each one of the virtual representations is assigned an identifier that is unique with respect to each other one of the virtual representations. Step 704 manages the virtual representations within the computing environment using the identifiers. Illustrative details and examples of these steps are explained in detail herein.

Illustrative embodiments are described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Cloud infrastructure can include private clouds, public clouds, and/or combinations of private/public clouds (hybrid clouds).

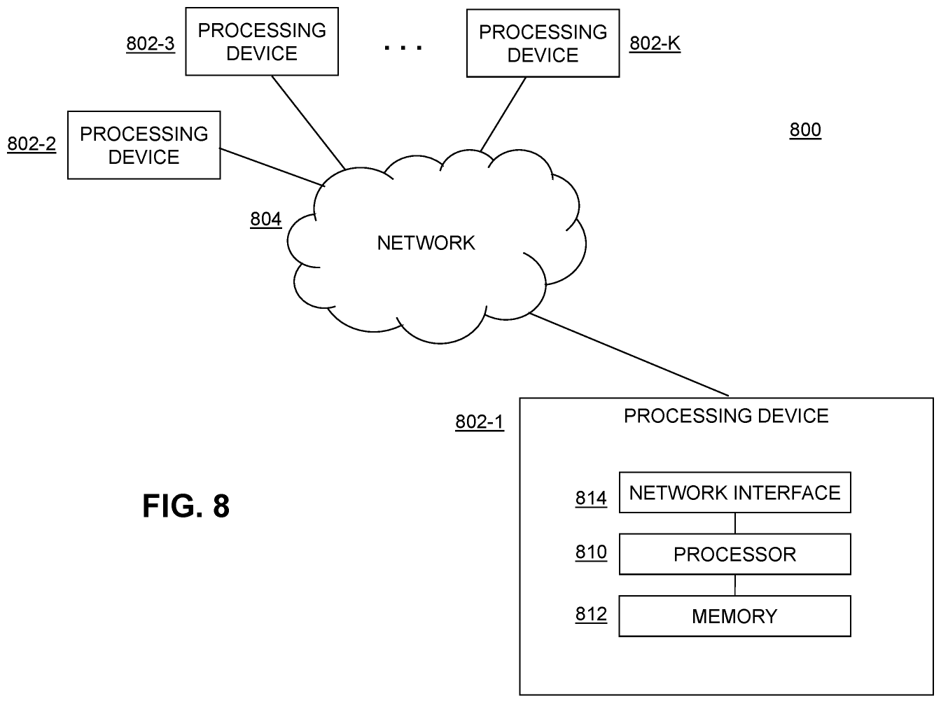

FIG. 8 depicts a processing platform 800 used to implement systems/processes/data 100 through 700 depicted in FIGS. 1 through 7 respectively, according to an illustrative embodiment. More particularly, processing platform 800 is a processing platform on which a computing environment with functionalities described herein can be implemented.

The processing platform 800 in this embodiment comprises a plurality of processing devices, denoted 802-1, 802-2, 802-3, . . . 802-K, which communicate with one another over network(s) 804. It is to be appreciated that the methodologies described herein may be executed in one such processing device 802, or executed in a distributed manner across two or more such processing devices 802. It is to be further appreciated that a server, a client device, a computing device or any other processing platform element may be viewed as an example of what is more generally referred to herein as a “processing device.” As illustrated in FIG. 8, such a device generally comprises at least one processor and an associated memory, and implements one or more functional modules for instantiating and/or controlling features of systems and methodologies described herein. Multiple elements or modules may be implemented by a single processing device in a given embodiment. Note that components described in the architectures depicted in the figures can comprise one or more of such processing devices 802 shown in FIG. 8. The network(s) 804 represent one or more communications networks that enable components to communicate and to transfer data therebetween, as well as to perform other functionalities described herein.

The processing device 802-1 in the processing platform 800 comprises a processor 810 coupled to a memory 812. The processor 810 may comprise a microprocessor, a microcontroller, an application-specific integrated circuit (ASIC), a field programmable gate array (FPGA) or other type of processing circuitry, as well as portions or combinations of such circuitry elements. Components of systems as disclosed herein can be implemented at least in part in the form of one or more software programs stored in memory and executed by a processor of a processing device such as processor 810. Memory 812 (or other storage device) having such program code embodied therein is an example of what is more generally referred to herein as a processor-readable storage medium. Articles of manufacture comprising such computer-readable or processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

Furthermore, memory 812 may comprise electronic memory such as random-access memory (RAM), read-only memory (ROM) or other types of memory, in any combination. The one or more software programs when executed by a processing device such as the processing device 802-1 causes the device to perform functions associated with one or more of the components/steps of system/methodologies in FIGS. 1 through 7. One skilled in the art would be readily able to implement such software given the teachings provided herein. Other examples of processor-readable storage media embodying embodiments of the invention may include, for example, optical or magnetic disks.

Processing device 802-1 also includes network interface circuitry 814, which is used to interface the device with the networks 804 and other system components. Such circuitry may comprise conventional transceivers of a type well known in the art.

The other processing devices 802 (802-2, 802-3, . . . 802-K) of the processing platform 800 are assumed to be configured in a manner similar to that shown for computing device 802-1 in the figure.

The processing platform 800 shown in FIG. 8 may comprise additional known components such as batch processing systems, parallel processing systems, physical machines, virtual machines, virtual switches, storage volumes, etc. Again, the particular processing platform shown in this figure is presented by way of example only, and the system shown as 800 in FIG. 8 may include additional or alternative processing platforms, as well as numerous distinct processing platforms in any combination.

Also, numerous other arrangements of servers, clients, computers, storage devices or other components are possible in processing platform 800. Such components can communicate with other elements of the processing platform 800 over any type of network, such as a wide area network (WAN), a local area network (LAN), a satellite network, a telephone or cable network, or various portions or combinations of these and other types of networks.

Furthermore, it is to be appreciated that the processing platform 800 of FIG. 8 can comprise virtual (logical) processing elements implemented using a hypervisor. A hypervisor is an example of what is more generally referred to herein as “virtualization infrastructure.” The hypervisor runs on physical infrastructure. As such, the techniques illustratively described herein can be provided in accordance with one or more cloud services. The cloud services thus run on respective ones of the virtual machines under the control of the hypervisor. Processing platform 800 may also include multiple hypervisors, each running on its own physical infrastructure. Portions of that physical infrastructure might be virtualized.

As is known, virtual machines are logical processing elements that may be instantiated on one or more physical processing elements (e.g., servers, computers, processing devices). That is, a “virtual machine” generally refers to a software implementation of a machine (i.e., a computer) that executes programs like a physical machine. Thus, different virtual machines can run different operating systems and multiple applications on the same physical computer. Virtualization is implemented by the hypervisor which is directly inserted on top of the computer hardware in order to allocate hardware resources of the physical computer dynamically and transparently. The hypervisor affords the ability for multiple operating systems to run concurrently on a single physical computer and share hardware resources with each other.

It was noted above that portions of the computing environment may be implemented using one or more processing platforms. A given such processing platform comprises at least one processing device comprising a processor coupled to a memory, and the processing device may be implemented at least in part utilizing one or more virtual machines, containers or other virtualization infrastructure. By way of example, such containers may be Docker containers or other types of containers.

The particular processing operations and other system functionality described in conjunction with FIGS. 1-8 are presented by way of illustrative example only, and should not be construed as limiting the scope of the disclosure in any way. Alternative embodiments can use other types of operations and protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the above-described embodiments of the invention are presented for purposes of illustration only. Many variations may be made in the particular arrangements shown. For example, although described in the context of particular system and device configurations, the techniques are applicable to a wide variety of other types of data processing systems, processing devices and distributed virtual infrastructure arrangements. In addition, any simplifying assumptions made above in the course of describing the illustrative embodiments should also be viewed as exemplary rather than as requirements or limitations of the invention.

What is claimed is:

1. A method, comprising:
assigning identifiers to virtual representations of physical items within a computing environment, wherein each one of the virtual representations is assigned an identifier that is unique with respect to each other one of the virtual representations; and
managing the virtual representations within the computing environment using the identifiers;
wherein the assigning and managing steps are performed by at least one processor and at least one memory storing executable computer program instructions.

2. The method of claim 1, wherein each identifier comprises an identifier field representing a location of the corresponding virtual representation within the computing environment.

3. The method of claim 1, wherein each identifier comprises an identifier field representing the physical item associated with the corresponding virtual representation.

4. The method of claim 1, wherein each identifier comprises an identifier field representing a provider of the physical item associated with the corresponding virtual representation.

5. The method of claim 1, wherein each identifier comprises an identifier field representing a type of data of the physical item associated with the corresponding virtual representation.

6. The method of claim 1, wherein each identifier comprises an identifier field representing a type of runtime environment of the physical item associated with the corresponding virtual representation.

7. The method of claim 1, wherein managing the virtual representations within the computing environment using the identifiers further comprises:
addressing a virtual representation within the computing environment using the unique identifier assigned thereto; and
one of executing and causing execution of a function with respect to the addressed virtual representation.

8. The method of claim 7, wherein the function comprises at least one of a benchmark function, a monitor function, and a report function.

9. The method of claim 1, wherein the computing environment comprises a distributed computing environment.

10. The method of claim 9, wherein the distributed computing environment comprises one or more of a cloud computing platform and an edge computing platform.

11. The method of claim 9, wherein the distributed computing environment comprises one or more on-premise locations where the virtual representations are deployed.

12. An apparatus, comprising:
at least one processor and at least one memory storing computer program instructions wherein, when the at least one processor executes the computer program instructions, the apparatus is configured to:
assign identifiers to virtual representations of physical items within a computing environment, wherein each one of the virtual representations is assigned an identifier that is unique with respect to each other one of the virtual representations; and
manage the virtual representations within the computing environment using the identifiers.

13. The apparatus of claim 12, wherein each identifier comprises one or more identifier fields respectively representing one or more of: a location of the corresponding virtual representation within the computing environment; the physical item associated with the corresponding virtual representation; a provider of the physical item associated with the corresponding virtual representation; a type of data of the physical item associated with the corresponding virtual representation; and a type of runtime environment of the physical item associated with the corresponding virtual representation.

14. The apparatus of claim 12, wherein, when managing the virtual representations within the computing environment using the identifiers, the apparatus is further configured to:
address a virtual representation within the computing environment using the unique identifier assigned thereto; and
one of execute and cause execution of a function with respect to the addressed virtual representation.

15. The apparatus of claim 14, wherein the function comprises at least one of a benchmark function, a monitor function, and a report function.

16. The apparatus of claim 12, wherein the computing environment comprises a distributed computing environment comprising one or more of at least one cloud computing platform, at least one edge computing platform, and at least one on-premise location where the virtual representations are deployed.

17. A computer program product stored on a non-transitory computer-readable medium and comprising machine executable instructions, the machine executable instructions, when executed, causing a processing device to perform steps of:
assigning identifiers to virtual representations of physical items within a computing environment, wherein each one of the virtual representations is assigned an identifier that is unique with respect to each other one of the virtual representations; and
managing the virtual representations within the computing environment using the identifiers.

18. The computer program product of claim 17, wherein each identifier comprises one or more identifier fields respectively representing one or more of: a location of the corresponding virtual representation within the computing environment; the physical item associated with the corresponding virtual representation; a provider of the physical item associated with the corresponding virtual representation; a type of data of the physical item associated with the corresponding virtual representation; and a type of runtime environment of the physical item associated with the corresponding virtual representation.

19. The computer program product of claim 17, wherein managing the virtual representations within the computing environment using the identifiers further comprises:
addressing a virtual representation within the computing environment using the unique identifier assigned thereto; and
one of executing and causing execution of a function with respect to the addressed virtual representation.

20. The computer program product of claim 19, wherein the function comprises at least one of a benchmark function, a monitor function, and a report function.
